(19) United States
(12) Patent Application Publication
(10) Pub. No.: US 2004/0183835 A1
(43) Pub. Date: Sep. 23, 2004

(54) System for displaying a graphical representation

(75) Inventors: Rudolf Muench, Koenigsbrunn (DE); Morten Enholm, Moss (NO); Tom Arild Pedersen, Oslo (NO)

Correspondence Address: GREENBLUM & BERNSTEIN, P.L.C., 1950 ROLAND CLARKE PLACE, RESTON, VA, 20191, US

(73) Assignee: VOITH PAPER PATENT GmbH, Heidenheim (DE)

(21) Appl. No.: 10/739,110

(22) Filed: Dec. 19, 2003

(30) Foreign Application Priority Data
Dec. 21, 2002 (EP) 020 28 694.4

(51) Int. Cl. G09G 5/00

(52) U.S. Cl. 345/800

(57) ABSTRACT

System and process for displaying a graphical representation having at least one scaling axis. The system comprises a computer, a display structured system and arranged to display the graphical representation for a scaling operation, and a pointer device structured and arranged to select one of the at least one scaling axis and to change the scaling of the one scaling axis. As the scaling of the one scaling axis is changed, the display system is structured to display a continuously updated graphical representation. The instant abstract is neither intended to define the invention disclosed in this specification nor intended to limit the scope of the invention in any way.

### CROSS-REFERENCE TO RELATED APPLICATIONS

The present application claims priority under 35 U.S.C. § 119 of European Patent Application No. 020 28 694.4 filed Dec. 21, 2002, the disclosure of which is expressly incorporated by reference herein in its entirety.

### BACKGROUND OF THE INVENTION

1. Field of the Invention

The present invention relates to a system for displaying a graphical representation having at least one scaling axis.

2. Discussion of Background Information

Coordinate systems are used in many areas for screen operation of control systems, for diagnostic systems and in related areas. Examples for two-dimensional coordinate systems are displays of time trends, spectra, cross directional quality profiles, and/or the like. Examples for three-dimensional coordinate systems are waterfall diagrams to display the development of spectra over time, or color maps, to visualize the development of cross directional quality profiles over time.

However, coordinate systems are in many cases difficult to use, especially regarding the scaling of the axes. The known display systems of the above-referenced kind comprise the following operation sequence:

1) a pointer device (e.g. a mouse) is used to select a scaling boundary value or a value defining the scaling by a mouse click, e.g. the lowest value of the x-axis;

2) to change the scaling value by entering a number or by using increment/decrement buttons;

3) the result of the scaling change becomes visible;

4) the pointer device is used to point to the next scaling value, e.g. the highest value of the x-axis;

5) like step 2);

6) like step 3).

Steps 4), 5) and 6) can be repeated several times until all scaling parameters are changed according to user desires.

In some cases a further step is needed at the beginning, with which step the pointer device is used to open a menu or a pop up window which gives access to the scaling data, on which steps 1) and 2) are performed.

In most applications two values are needed for each scaling dimension. These two values are usually defined as either “high” and “low” boundaries of the displayed data, or “mean value” and “span”. The “mean value” is sometimes also called “offset”, the “span” is sometimes given as a “scaling factor”.

Thus, a typical two-dimensional coordinate system requires the change of four values to define a user desired scaling. If there are multiple curves in the same coordinate system with independent scaling requirements, for example three scaling requirements, twelve values have to be changed. This consumes time and it is often hard to overlook for the user, what the scaling changes will do to the curve. Thus, usually the user iteratively approaches an “optimum” scaling.

### SUMMARY OF THE INVENTION

The present invention provides a more intuitive way for scaling operations and for eliminating the above-mentioned problems.

The present invention provides a system for displaying a graphical representation having at least one scaling axis, that includes a computer, a display and a pointer device. The displaying system is laid out for a scaling operation wherein the pointer device is used to click on to a scaling axis of the graphical representation or a symbol thereof and the scaling is changed by a drag operation performed by the pointer device so that the displayed graphical representation is continuously updated during the drag operation.

With this inventive system, a more intuitive way for scaling operations is provided. Less operation steps are required, and the feedback is given to the uses immediately. Thus, while continually changing the scaling, the changes of the graphical representation, e.g. a diagram and/or the like, can be viewed. The inventive system allows the user a much better control of scaling.

The graphical representation can, e.g. be a graphical representation for numerical data.

In an exemplary embodiment of the system according to the present invention, the graphical representation comprises at least one coordinate system.

The displaying system is preferably laid out for a scaling operation wherein the pointer device is clicked directly on to the scaling axis. Alternatively, the pointer device may be clicked on to a symbol of the scaling axis. In this case, the symbol of the scaling axis can preferably be located at any place of the display. The symbol of the scaling axis may, e.g., be located in a pop up window.

According to another advantageous embodiment of the inventive system the symbol of the scaling axis may comprise a slider.

In an advantageous embodiment a high value and/or a low value of the scaling axis is changed by a corresponding drag operation. In this case, the pointer device preferably includes two pointer buttons for changing the high value and the low value, respectively.

Alternatively, or additionally, a mean value and/or the span of the scaling axis is advantageously changed by a corresponding drag operation. In this case, the pointer device preferably includes two pointer buttons for changing the mean value and the span, respectively.

According to another advantageous embodiment of the inventive system, the display has associated with the scaling axis a sensitive area for changing the high value and/or a sensitive area for changing the low value of the scaling axis by a corresponding drag operation.

Alternatively or additionally, the display may have associated with the scaling axis a sensitive area for changing the mean value and/or a sensitive area for changing the span of the scaling axis by a corresponding drag operation.

In an expedient practical embodiment, before carrying out the drag operation, the pointer device is used to point to a selector to choose which scaling parameter is to be changed.

Preferably, the pointer device comprises a mouse, a touch pad, a touch screen and/or the like.

The system according to the present invention allows to a user a much better control of scaling. For example, it allows visual correlation of two curves, by quickly adjusting the scaling of one curve in either dimension, until the two curves can be compared easily.

“Drag”-operations are very intuitive, and proved to increase operation comfort also in other areas like zooming, e.g. defining the zoom-in area by click and move the pointer over the interested part of a graphical object, moving graphical objects, e.g. windows, and rotating of objects, e.g. in drawing programs. The same advantage is available now for scaling operations.

The present invention is directed to a system for displaying a graphical representation having at least one scaling axis. The system comprises a computer, a display structured system and arranged to display the graphical representation for a scaling operation, and a pointer device structured and arranged to select one of the at least one scaling axis and to change the scaling of the one scaling axis. As the scaling of the one scaling axis is changed, the display system is structured to display a continuously updated graphical representation.

According to a feature of the instant invention, the pointer device can be structured to operate in a click and drag manner, such that the one scaling axis is selected by clicking and the scale is changed by dragging. The display system can further exhibit a symbol for the at least one scaling axis, and the one scaling axis can be selected by clicking on one of the one scaling axis or the symbol of the one scaling axis.

In accordance with another feature of the present invention, the graphical representation may be a graphical representation for numerical data.

According to still another feature, the graphical representation may include at least one coordinate system.

Still further, the pointer device can be structured to click directly on the one scaling axis.

The pointer device may be structured to click indirectly on the one scaling axis. Further, the pointer device can be structured to click directly on a symbol of the one scaling axis. The symbol of the one scaling axis may be located at any place of the display system, and the symbol of one the scaling axis can be located in a pop up window. Still further, the symbol of the one scaling axis can include a slider.

At least one of a high value and a low value of the one scaling axis may be changed by a drag operation of the pointer device. The pointer device can include two pointer buttons for separately changing the high value and the low value.

At least one of a mean value and a span of the one scaling axis can be changed by a drag operation of the pointer device. The pointer device may include two pointer buttons for separately changing the mean value and the span.

The one scaling axis on the display system can include at least one of a sensitive area structured and arranged to change a high value of the one scaling axis by a drag operation of the pointer device and a sensitive area structured and arranged to change a low value of the one scaling axis by a drag operation of the pointer device.

The one scaling axis on the display may include at least one of a sensitive area structured and arranged to change a mean value of the one scaling axis by a drag operation of the pointer device and a sensitive area structured and arranged to change a span of the one scaling axis by a drag operation of the pointer device.

The pointer can be structured to perform drag operations and the display device can further display a selector that comprises a plurality of scaling parameters. Before carrying out the drag operation, the pointer device can be pointed to the selector to choose which of the plurality of scaling parameters is to be changed.

The pointer device can include at least one of a mouse, a touch pad, and a touch screen.

The present invention is directed to a process for displaying a graphical representation having at least one scaling axis on a display system coupled to a computer. The process includes selecting one of the at least scaling axis, changing the scaling of the selected scaling axis, and continuously updating the displayed graphical representation as the selected scaling axis is changed.

In accordance with a feature of the invention, a pointer device is coupled to the computer, and the process further includes utilizing the pointer device in a click and drag manner, such that the selected scaling axis is selected by clicking and the scale is changed by dragging. The display system can display a symbol to represent the at least one scaling axis, and the process may further include selecting the selected scaling axis by clicking on the selected scaling axis or the symbol for the selected scaling axis.

Further, the process can include changing at least one of a high value and a low value of the selected scaling axis by a drag operation of the pointer device. The pointer device may include two pointer buttons, and the process can further include separately changing the high value and the low value with respective ones of the two pointer buttons. Moreover, the process can include changing at least one of a mean value and a span of the selected scaling axis by a drag operation of the pointer device. The pointer device can include two pointer buttons for separately changing the mean value and the span.

The selected scaling axis on the display system may include at least one of a sensitive area structured and arranged to change a high value of the one scaling axis by a drag operation of the pointer device and a sensitive area structured and arranged to change a low value of the selected scaling axis by a drag operation of the pointer device.

In accordance with still yet another feature of the present invention, the selected scaling axis on the display can include at least one of a sensitive area structured and arranged to change a mean value of the selected one scaling axis by a drag operation of the pointer device and a sensitive area structured and arranged to change a span of the selected scaling axis by a drag operation of the pointer device.

Other exemplary embodiments and advantages of the present invention may be ascertained by reviewing the present disclosure and the accompanying drawing.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 illustrates the operation of a trend picture with three curves, three y-axes, and one x-axis which is common for all curves; and

FIG. 2 illustrates the operation of a color map display.

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

The corresponding embodiments of the system for displaying a graphical representation comprises a computer, a screen or display and a pointer device like a mouse, a touch pad, a touch screen and/or the like. The pointer device needs to be able to use click and drag operations, analog to a mouse with at least one button. The computer displays a coordinate system, or any other graphical representation for numerical data, with at least one scaling axis and/or corresponding symbols. The scaling operation can be performed by a user of the pointing or pointer device, e.g. in the following steps:

1) the pointer device is used to point or click on to an axis, or a symbol thereof, of the coordinate systems;

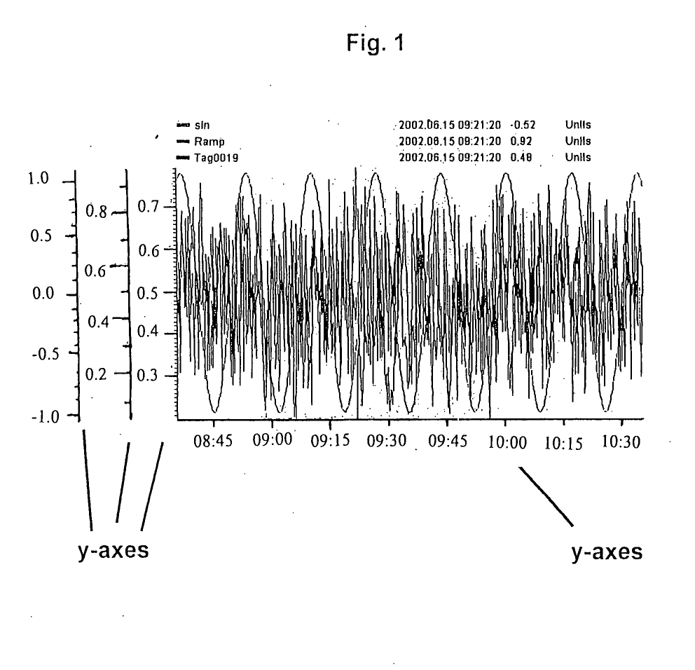

2) scaling is changed with “drag” operations which means click and move, while the click is still active; the displayed information, i.e. the curve in the trend display of FIG. 1, is continuously updated during the moving action.

The symbol for the axis can be i.e. a slider symbol, which can be located at any place on the user screen or display, i.e. also in a pop up window. In particular the above step 2) gives advantage for the user. With the corresponding feature, the curve in the trend display is continuously updated during the drag operation.

Preferably, it is pointed to the axis directly instead to a slider, because this is even more intuitive for the user. However, also a slider could be used.

To change the “high” and “low” value, or the “mean value” and “span”, two pointer buttons can be used. For example, the mean value could be changed by a drag operation with the left mouse button, and the span could be changed by a drag operation with the right mouse button.

Alternatively, the screen or display could have associated to an axis a sensitive area to adjust the span and another sensitive area to adjust the mean value by a drag operation. In this case one mouse button would be sufficient. It is also possible to control either span, mean value, low or high value, by having four sensitive screen or display areas for one axis.

It would also be possible to have a two-stage process:

1) point to a selector, to choose which scaling parameter has to be changed;

2) point to a sensitive area, i.e. a symbol for the axis, and drag to change the corresponding value.

Also in this case one mouse button would be sufficient.

Preferred are embodiments with two mouse buttons, because of smaller space requirements in the display, wherein only one pointer sensitive area is required per axis.

FIG. 1 shows an exemplary embodiment for the operation of a time trend picture with three curves, three y-axes, and one x-axis which is common for all curves.

The operation of this time trend picture can, e.g., be as follows:

Independently for Each y-axis:

left click+drag: move scaling (add offset)

right click+drag up: increase scaling factor

right click+drag down: decrease scaling factor

For the Common x-axis:

left click+drag: move scaling (add offset)

right click+drag right: increase scaling factor

right click+drag left: decrease scaling factor (“offset and scaling factor” work here only after zooming in)

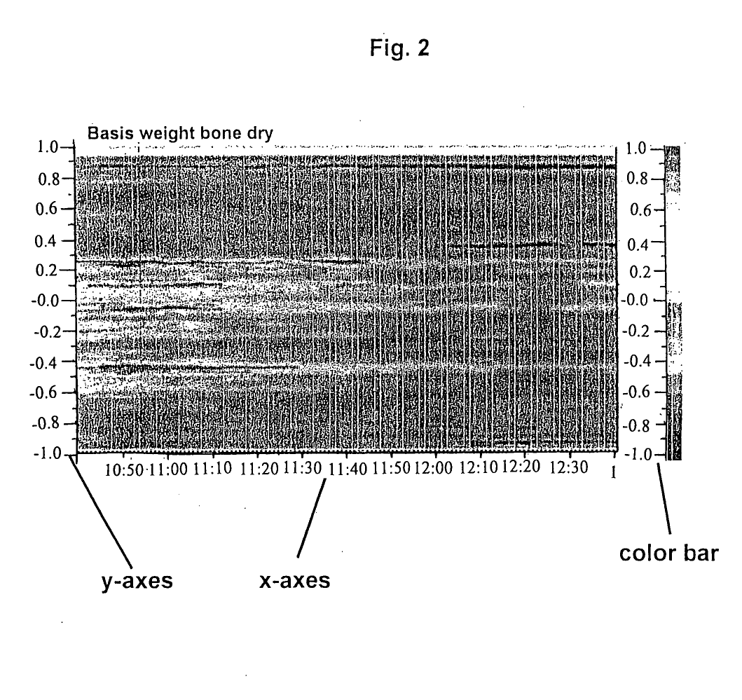

FIG. 2 shows the operation of a color map display (operation like trend).

The operation of the left y-axis can be as follows:

left click+drag: move scaling (add offset)

right click+drag up: increase scaling factor

right click+drag down: decrease scaling factor

The operation of the x-axis can be as follows:

left click+drag: move scaling (add offset)

right click+drag right: increase scaling factor

right click+drag left: decrease scaling factor

The operation of the right y-axis or color bar could be as follows:

left click+drag: move scaling

right click+drag up: increase scaling factor

right click+drag down: decrease scaling factor

The color bar does not change while scaling.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed:

1. A system for displaying a graphical representation having at least one scaling axis, comprising:
a computer;
a display structured system and arranged to display the graphical representation for a scaling operation; and
a pointer device structured and arranged to select one of the at least one scaling axis and to change the scaling of the one scaling axis,
wherein, as the scaling of the one scaling axis is changed, said display system is structured to display a continuously updated graphical representation.

2. The system in accordance with claim 1, wherein said pointer device is structured to operate in a click and drag manner, such that the one scaling axis is selected by clicking and the scale is changed by dragging.

3. The system in accordance with claim 2, wherein the display system further exhibits a symbol for the at least one scaling axis, and
wherein the one scaling axis is selected by clicking on one of the one scaling axis or the symbol of the one scaling axis.

4. The system in accordance with claim 1, wherein said graphical representation is a graphical representation for numerical data.

5. The system in accordance with claim 1, wherein said graphical representation comprises at least one coordinate system.

6. The system in accordance with claim 1, wherein said pointer device is structured to click directly on the one scaling axis.

7. The system in accordance with claim 1, wherein said pointer device is structured to click indirectly on the one scaling axis.

8. The system in accordance with claim 7, wherein said pointer device is structured to click directly on a symbol of the one scaling axis.

9. The system in accordance with claim 8, wherein said symbol of the one scaling axis is located at any place of the display system.

10. The system in accordance with claim 8, wherein said symbol of one the scaling axis is located in a pop up window.

11. The system in accordance with claim 8, wherein said symbol of the one scaling axis comprises a slider.

12. The system in accordance with claim 1, wherein at least one of a high value and a low value of the one scaling axis is changed by a drag operation of the pointer device.

13. The system in accordance with claim 12, wherein said pointer device comprises two pointer buttons for separately changing the high value and the low value.

14. The system in accordance with claim 1, wherein at least one of a mean value and a span of the one scaling axis is changed by a drag operation of the pointer device.

15. The system in accordance with claim 14, wherein said pointer device comprises two pointer buttons for separately changing the mean value and the span.

16. The system in accordance with claim 1, wherein said one scaling axis on said display system comprises at least one of a sensitive area structured and arranged to change a high value of the one scaling axis by a drag operation of the pointer device and a sensitive area structured and arranged to change a low value of the one scaling axis by a drag operation of the pointer device.

17. The system in accordance with claim 1, wherein said one scaling axis on said display comprises at least one of a sensitive area structured and arranged to change a mean value of said one scaling axis by a drag operation of the pointer device and a sensitive area structured and arranged to change a span of the one scaling axis by a drag operation of said pointer device.

18. The system in accordance with claim 1, wherein said pointer is structured to perform drag operations and said display device further displays a selector that comprises a plurality of scaling parameters, and
wherein, before carrying out the drag operation, said pointer device is pointed to said selector to choose which of said plurality of scaling parameters is to be changed.

19. The system in accordance with claim 1, wherein said pointer device comprises at least one of a mouse, a touch pad, and a touch screen.

20. A process for displaying a graphical representation having at least one scaling axis on a display system coupled to a computer, said process comprising:
selecting one of the at least scaling axis;
changing the scaling of the selected scaling axis; and
continuously updating the displayed graphical representation as the selected scaling axis is changed.

21. The process in accordance with claim 20, wherein a pointer device is coupled to the computer, and the process further comprises utilizing the pointer device in a click and drag manner, such that the selected scaling axis is selected by clicking and the scale is changed by dragging.

22. The process in accordance with claim 21, wherein the display system displays a symbol to represent the at least one scaling axis, and the process further comprises selecting the selected scaling axis by clicking on the selected scaling axis or the symbol for the selected scaling axis.

23. The process in accordance with claim 21, further comprising changing at least one of a high value and a low value of the selected scaling axis by a drag operation of the pointer device.

24. The process in accordance with claim 23, wherein the pointer device comprises two pointer buttons, and the process further comprises separately changing the high value and the low value with respective ones of the two pointer buttons.

25. The process in accordance with claim 21, further comprising changing at least one of a mean value and a span of the selected scaling axis by a drag operation of the pointer device.

26. The process in accordance with claim 25, wherein the pointer device comprises two pointer buttons for separately changing the mean value and the span.

27. The process in accordance with claim 20, wherein the selected scaling axis on the display system comprises at least one of a sensitive area structured and arranged to change a high value of the one scaling axis by a drag operation of the pointer device and a sensitive area structured and arranged to change a low value of the selected scaling axis by a drag operation of the pointer device.

28. The process in accordance with claim 20, wherein the selected scaling axis on the display comprises at least one of a sensitive area structured and arranged to change a mean value of the selected one scaling axis by a drag operation of the pointer device and a sensitive area structured and arranged to change a span of the selected scaling axis by a drag operation of the pointer device.
